(19) United States
(12) Patent Application Publication
(10) Pub. No.: US 2013/0151114 A1
(43) Pub. Date: Jun. 13, 2013

(54) METHOD OF MANAGING AUXILIARY FUEL SYSTEM FOR FFV

(71) Applicant: Jin Woo KIM, Gunpo-si (KR)

(72) Inventor: Jin Woo KIM, Gunpo-si (KR)

(73) Assignee: Hyundai Motor Company, Seoul (KR)

(21) Appl. No.: 13/532,339

(22) Filed: Jun. 25, 2012

(30) Foreign Application Priority Data
Dec. 9, 2011 (KR) 10-2011-0131834

(51) Int. Cl. F02D 19/06

(52) U.S. Cl. 701/102

(57) ABSTRACT

A method of managing an auxiliary fuel system for a flexible fuel vehicle (FFV), may include monitoring a number of operations of the auxiliary fuel system when an engine of a vehicle starts, determining whether it may be necessary to perform maintenance of the auxiliary fuel system on the ground that the auxiliary fuel system has not been used for a predetermined time period in which the number of starts of the engine reaches a predetermined number, on the basis of the result of the monitoring, and operating the auxiliary fuel system in accordance with a predetermined setting, when the determining of whether it may be necessary to perform the maintenance of the auxiliary fuel system reveals that the auxiliary fuel system has not been used for the predetermined time period.

### CROSS-REFERENCE TO RELATED APPLICATIONS

The present application claims priority to Korean Patent Application No. 10-2011-0131834 filed on Dec. 9, 2011, the entire contents of which is incorporated herein for purposes by this reference.

### BACKGROUND OF THE INVENTION

1. Field of the Invention

The present invention relates to an auxiliary fuel system for a flexible fuel vehicle (FFV), and more particularly, to a technology for use in an FFV which uses ethanol as a main fuel and gasoline as an auxiliary fuel, in which the technology enables an auxiliary fuel system used to supply gasoline as fuel to exhibit stable performance at all times.

2. Description of Related Art

With the sharp increase in global oil prices, there is a sharp increase in the demand for ethanol fuel which is relatively inexpensive compared to gasoline, especially in Brazil, China, East Asia, the United States, and other places. Moreover, research and development into technology related to FFVs which are capable of using ethanol fuel have been ongoing.

The stoichiometric air-fuel ratio of ethanol used in FFVs is 9:1, which means that relative to gasoline a far greater amount of ethanol is required to obtain the same amount of energy. In vehicles, an ethanol concentration in fuel should be determined so that a fuel quantity in a control system can be corrected in accordance with the ethanol concentration. In this way, an engine can smoothly run on any fuel, that is, on any mixture of gasoline and ethanol, from pure gasoline up to 100% ethanol.

Especially when an engine starts, ethanol is consumed in an amount several times the amount of gasoline, which is required for the engine starting. Moreover, at temperatures of 12° C. or below, it is extremely difficult to start the engine with 100% ethanol. Accordingly, in order to solve this problem, as illustrated in FIG. 1, most FFVs are equipped with an auxiliary fuel system 500 for the purpose of starting the engine with gasoline in such a situation. The auxiliary fuel system 500 includes an auxiliary fuel tank 502 which stores gasoline and an auxiliary fuel pump 506 which pumps gasoline into a cold starting injector 504. That is, the auxiliary fuel system 500 constitutes an additional fuel supplying system which is separate from a main fuel tank 508 which stores ethanol and a main injector 510.

Whether to operate the auxiliary fuel system 500 is determined depending on the concentration of ethanol and the starting water temperature. Depending on regions and weather of the regions where vehicles are used, the auxiliary fuel system 500 may stay unused for a long period of time. When the auxiliary fuel system 500 is not in use over a very long period of time, a problem arises in which the auxiliary fuel pump 506 and the connected valves become stuck or the holes of nipples that are part of pipes for gasoline supply are clogged.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method of managing an auxiliary fuel system of an FFV in which an engine is selectively supplied with a main fuel and an auxiliary fuel depending on situations by separate fuel supply systems. To be specific, even though the FFV has not encountered a situation in which it is necessary to use the auxiliary fuel system over a long period of time, the auxiliary fuel system is appropriately managed so that various parts of the auxiliary fuel system may not become stuck or fuel passages may not be clogged. This ensures the stable operation of the auxiliary fuel system and improves the reliability of a vehicle, which contributes to an increase in the merchantable quality of a vehicle.

According to one aspect of the invention, there is provided a method of managing an auxiliary fuel system for an FFV including monitoring the number of operations of an auxiliary fuel system every time an engine of a vehicle starts, determining whether it is necessary to perform maintenance of the auxiliary fuel system on the ground that the auxiliary fuel system may have not been operated even once until the number of starts of the engine reaches a predetermined number, and operating, when the determining of whether it is necessary to perform maintenance of the auxiliary fuel system reveals that the auxiliary fuel system may have never operated, the auxiliary fuel system in accordance with a predetermined setting.

According to another aspect of the invention, there is provided a method of managing an auxiliary fuel system for an FFV including monitoring the number of operations of the auxiliary fuel system every time an engine of a vehicle starts, determining whether it is necessary to perform maintenance of the auxiliary fuel system on the ground that the auxiliary fuel system may have not been operated for a predetermined period, determining, when it is determined that it is necessary to perform maintenance of the auxiliary fuel system, whether the vehicle is running, whether the number of revolutions of the engine is equal to or greater than a predetermined number, and whether an amount of air is equal to or greater than a predetermined amount, and operating the auxiliary fuel system in accordance with a predetermined setting when it is determined that the vehicle is running, the number of revolutions of the engine is equal to or greater than the predetermined number, and the amount of air is greater than the predetermined amount.

The present invention provides a method of properly managing an auxiliary fuel system in an FFV in which the engine is selectively supplied with a main fuel and an auxiliary fuel by separate fuel supplying systems. According to the invention, even though a vehicle has stayed in a state in which it is not necessary to use the auxiliary fuel system for a long period of time, since the auxiliary fuel system is appropriately managed, various parts of the auxiliary fuel system are prevented from being stuck and the passage of fuel is prevented from being clogged. Accordingly, it is possible to secure the stable operability of the auxiliary fuel system and increase the reliability of a vehicle, which contributes to an increase in the merchantable quality of a vehicle.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a conceptual schematic diagram illustrating an auxiliary fuel system for an FFV according to the related art.

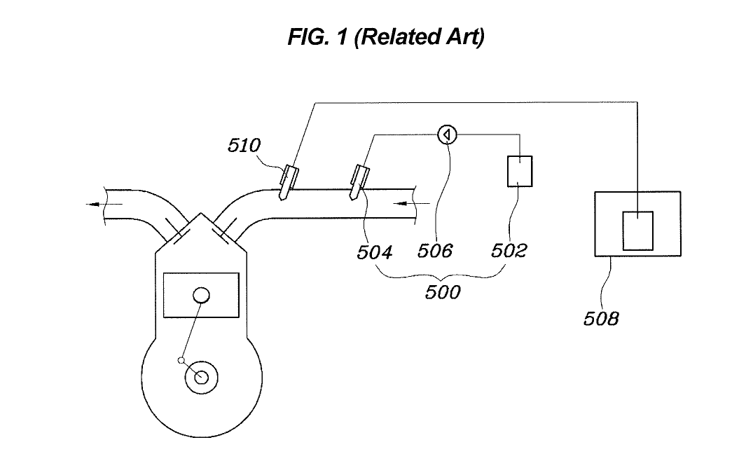

FIG. 2 is a flowchart illustrating an example of a method of managing an auxiliary fuel system for an FFV according to one embodiment of the invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

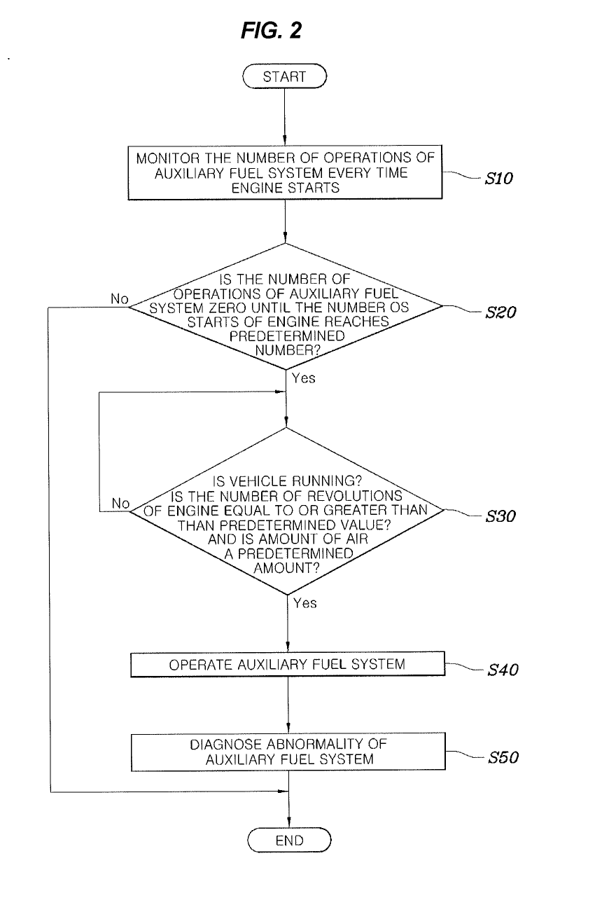

Referring to FIG. 2, a method of managing an auxiliary fuel system for an FFV according to an embodiment includes an engine-starting monitoring step (S10) of monitoring the number of operations of an auxiliary fuel system every time the engine of a vehicle starts, a maintenance necessity determining step (S20) of determining whether it is necessary to perform maintenance of the auxiliary fuel system on the basis of the result of the engine-starting monitoring step (10) on the ground that the auxiliary fuel system has not been operated until the number of starts of the engine has reached a predetermined number, and an operating step (S40) of operating, when the maintenance necessity determining step (20) reveals that the auxiliary fuel system has not operated, the auxiliary fuel system in accordance with a predetermined setting.

That is, every time the engine of the FFV vehicle is started, whether the starting of the engine is made by the auxiliary fuel system is monitored. When the monitoring reveals that the auxiliary fuel system has not been used for a predetermined period of time or longer, the auxiliary fuel system is intentionally operated so as to prevent negative effects caused by long-period no-usage of the auxiliary fuel system, such as the sticking of various parts and the clogging of holes. In this way, the auxiliary fuel system is able to maintain a smooth and stable operation state.

The predetermined number of starts of the engine which is the basis for determining the necessity of the maintenance of the auxiliary fuel system is an arbitrary value by which the stable operation of the auxiliary fuel system is ensured and which is set on an experimental basis.

As described above, in addition to the criteria of the determination of whether the number of starts of the engine which are carried out not by the auxiliary fuel system exceeds the predetermined number, the necessity of maintenance of the auxiliary fuel system can be determined in accordance with another criteria such as whether a period of time during which the starts of the engine are made not by the auxiliary fuel system exceeds a predetermined period of time.

When the maintenance necessity determining step (20) determines that it is necessary to operate the auxiliary fuel system, before carrying out the operating step (40), a maintenance condition determining step (S30) is carried out, which determines whether a state after performing the operating step (S40) satisfies a condition under which there is nearly no change in the air-fuel ratio and the operability of the engine. Only when it is determined that the condition is satisfied, the operating step (S40) is performed. This is beneficial in maintaining the stable operation state of the engine.

The maintenance condition determining step (S30) determines whether a vehicle is running, whether the number of revolutions of the engine is equal to or greater a predetermined number and whether an amount of air that the engine takes in is equal to or greater than a predetermined amount. When the determining reveals that the vehicle is running, the number of revolutions of the engine is equal to or greater than the predetermined number and the amount of air that the engine takes in is equal to or greater than the predetermined amount, the maintenance condition for performing the operating step (S40) is determined to be satisfied.

The predetermined number of revolutions of the engine and the predetermined amount of air are appropriately set on an experimental basis in accordance with the purpose, to values by which a slight amount of gasoline that is jetted into the engine in the operating step (S40) does not cause a remarked change in the air-fuel ratio or does not cause any trouble in the operation of the engine.

In the operating step (S40), the predetermined setting for operating the auxiliary fuel system may be set in such a manner that the auxiliary fuel system will be operated a predetermined number of times at predetermined intervals. For example, the auxiliary fuel system can be controlled such that gasoline may be jetted twice at intervals of one second. The settings of control of the auxiliary fuel system can be changed on the basis of the type of the auxiliary fuel system, engine displacement, or other conditions.

It is preferable to further perform a diagnosing step (S50) of diagnosing an abnormality of the auxiliary fuel system after performing the operating step (S40).

According to the above-described embodiment, even when a vehicle stays in conditions over a long period of time under which it is not necessary to use an auxiliary fuel system, the auxiliary fuel system is configured to be operated. Accordingly, the auxiliary fuel system may maintain its smooth operability, which contributes to an increase in the reliability of the vehicle.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of managing an auxiliary fuel system for a flexible fuel vehicle (FFV), comprising:
monitoring a number of operations of the auxiliary fuel system when an engine of a vehicle starts;
determining whether it is necessary to perform maintenance of the auxiliary fuel system on the ground that the auxiliary fuel system has not been used for a predetermined time period in which the number of starts of the engine reaches a predetermined number, on the basis of the result of the monitoring; and
operating the auxiliary fuel system in accordance with a predetermined setting, when the determining of whether it is necessary to perform the maintenance of the auxiliary fuel system reveals that the auxiliary fuel system has not been used for the predetermined time period.

2. The method of managing the auxiliary fuel system for the FFV according to claim 1, further including
determining, when the determining of whether it is necessary to perform the maintenance of the auxiliary fuel system reveals that it is necessary to perform the maintenance of the auxiliary fuel system, whether a maintenance condition is satisfied under which the result of the operating of the auxiliary fuel system has no impact on a change in an air-fuel ratio of the engine and on operability of the engine, before performing the operating of auxiliary fuel system,
wherein the operating of the auxiliary fuel system is performed when the maintenance condition is determined to be satisfied.

3. The method of managing the auxiliary fuel system for the FFV according to claim 2,
wherein the determining of whether the maintenance condition is satisfied determines whether the vehicle is running, whether a number of revolutions of the engine is equal to or greater than a predetermined number, and whether an amount of air that the engine takes in is equal to or greater than a predetermined amount, and determines that the maintenance condition for operating the auxiliary fuel system is satisfied when it is determined that the vehicle is running, the number of revolutions of the engine is equal to or greater than the predetermined number, and the amount of the air that the engine takes in is equal to or greater than the predetermined amount.

4. The method of managing the auxiliary fuel system for the FFV according to claim 1,
wherein the predetermined setting in the operating of the auxiliary fuel system is a setting that causes the auxiliary fuel system to be operated in a predetermined number of times at predetermined intervals.

5. The method of managing the auxiliary fuel system for the FFV according to claim 1, further including
diagnosing abnormality of the auxiliary fuel system after performing the operating of the auxiliary fuel system.

6. A method of managing an auxiliary fuel system for a flexible fuel vehicle (FFV), comprising:
monitoring a number of operations of the auxiliary fuel system when an engine of a vehicle starts;
determining whether it is necessary to perform maintenance of the auxiliary fuel system on the ground that the auxiliary fuel system has not been operated for a predetermined period;
determining, when it is determined that it is necessary to perform the maintenance of the auxiliary fuel system, whether the vehicle is running, whether a number of revolutions of the engine is equal to or greater than a predetermined number, and whether an amount of air is equal to or greater than a predetermined amount; and
operating the auxiliary fuel system in accordance with a predetermined setting, when it is determined that the vehicle is running, the number of revolutions of the engine is equal to or greater than the predetermined number, and the amount of air is equal to or greater than the predetermined amount.

7. The method of managing an auxiliary fuel system for the FFV according to claim 6,
wherein the predetermined setting is a setting that causes the auxiliary fuel system to jet gasoline two times at an interval of one second.

8. The method of managing an auxiliary fuel system for the FFV according to claim 6, further including
diagnosing abnormality of the auxiliary fuel system after performing the operating of the auxiliary fuel system.

9. The method of managing an auxiliary fuel system for the FFV according to claim 6,
wherein the auxiliary fuel system is on standby until the conditions that the vehicle is running, the number of revolutions of the engine is equal to or greater than the predetermined number, and the amount of air is equal to or greater than the predetermined amount are satisfied.
